(19) United States
(12) Patent Application Publication
(10) Pub. No.: US 2019/0044942 A1
(43) Pub. Date: Feb. 7, 2019

(54) Deep Learning for Behavior-Based, Invisible Multi-Factor Authentication

(71) Applicant: TwoSense, Inc., New York, NY (US)

(72) Inventors: Dawud Gordon, Brooklyn, NY (US); John Tanios, Brooklyn, NY (US); Oleksii Levkovskyi, Brooklyn, NY (US)

(21) Appl. No.: 16/051,465

(22) Filed: Jul. 31, 2018

Related U.S. Application Data
(60) Provisional application No. 62/539,777, filed on Aug. 1, 2017.
(60) Provisional application No. 62/648,884, filed on Mar. 27, 2018.

(51) Int. Cl. H04L 29/06; G06F 21/31; G06F 21/32; G06K 9/62; G06N 3/02; G06N 7/00; H03M 1/12; H03M 13/39

(52) U.S. Cl. CPC H04L 63/0861; G06F 21/316; G06F 21/32; H04L 63/105; H04L 63/107; H04L 2463/082; G06N 3/02; G06N 7/005; H03M 1/12; H03M 13/3972; G06K 9/6267

(57) ABSTRACT

Biometric behavior-based authentication may be enhanced by using convolutional deep neural networks to learn subject-specific features for each subject. The advantage is two-fold. First the need for a domain expert is eliminated, and the search space can be algorithmically explored. Second, the features that allow each subject to be differentiated from other subjects may be used. This allows the algorithm to learn the aspects of each subject that make them unique, rather than taking a set of fixed aspects and learning how those aspects are differentiated across subjects. The combined result is a far more effective authentication in terms of reduction of errors. Behavior-based, invisible multi-factor authentication (BIMFA) mays also automate the responses to authentication second and third factor requests (something you have and something you are). BIMFA leverages continuous, invisible behavioral biometrics on user devices to gain a continuous estimate of the authorization state of the user across multiple devices without requiring any explicit user interaction or input for authentication. As a result, BIMFA can demonstrate that a device is under the control of the authorized user without requiring any direct user interaction.

### RELATED APPLICATIONS

This application claims the benefit of the following two U.S. Provisional patent applications, all of which are incorporated by reference in their entirety:

1) Ser. No. 62/539,777, filed on Aug. 1, 2017; and

2) Ser. No. 62/648,884, filed on Mar. 27, 2018.

### FIELD OF THE DISCLOSURE

The present disclosure is in the field of systems and methods for improving behavior-based authentication systems.

### BACKGROUND

Using hardware and software sensors on mobile, wearable and portable devices, as well systems and interfaces that a user is interacting with, the behavior of a user may be observed. Using traditional machine learning methods for behavioral biometrics requires a domain expert to select features that allow individuals to be differentiated. These features can be behavioral aspects like gait, typing behavior, daily temporal routines, etc. The values of these features are aggregated together in a specific order to create a feature vector. A machine learning algorithm is then used to model patterns in that feature vector for a particular subject and differentiate them from other subjects. Using this model, and behavioral observations of a subject, the feature vector is generated and passed through the model to yield a classification or indication of whether this data was generated by the modeled subject or not. This is the process of biometric behavioral authentication.

There are two or more problems with this approach. The first is that the columns in the feature vectors (meaning the types of features) are the same for each subject, and the differentiation is only based on the values. This leads to reduced performance for biometric authentication. The second is that a domain expert is needed to select the correct features for authentication, which is essentially an infinite search space.

Other existing solutions focus on feature selection, which allow a wider set of features to be analyzed that would be computationally intractable for authentication but reduces the length of the vector by combining features or finding those features that are most useful in terms of providing accuracy.

Feature selection methods still assume the same columns (features) will be used for each subject which is not useful for behavioral biometrics. Also, if the domain expert did not specify a feature that would have a strong positive impact on the performance, that information will still not be present after feature selection. However, this approach may result in different feature expressions per subject but requires an expert to have universal coverage in the underlying features which is impossible.

Further, Multi-factor authentication (MFA) is used to prevent attacks that leverage device and credential misuse by unauthorized parties. The first factor is something the user knows, the second is something the user has (e.g. a device or a key), and the third is something the user is (e.g. a biometric). In this way, should one of the three be compromised, the attacker is still not granted entry.

The problem, however, is that multi-factor authentication often creates friction for the authorized user. An attacker may be prevented from gaining access, however the vast majority of authentication (auth) attempts are made by authorized users who now must jump through extra hoops to gain access.

As a secondary problem, due to the extra friction of authentication, where authorized users are required to spend time and effort to prove they are authorized, MFA is used as infrequently as possible, providing only the minimum security necessary.

As a tertiary problem, MFA only ensures authorization at the exact instant in time at which the user passes the MFA challenge. After that, a period of time, called a session is agreed upon during which that authorization is deemed to still be valid. This creates a hole after MFA through which an attacker may take control of an initiated session without having to demonstrate authorization. This hole can be reduced by increasing the frequency of MFA challenges, but only at the cost of heavy friction to the authorized user.

The solution, behavior-based, invisible MFA (BIMFA), solves these problems by automating the responses to second and third factor requests (something you have and something you are). It leverages continuous, invisible behavioral biometrics on user devices to gain a continuous estimate of the authorization state of the user across multiple devices without requiring any explicit user interaction or input for authentication. As a result, BIMFA can demonstrate that a device is under the control of the authorized user without requiring any interaction for MFA.

By doing so, it removes all friction from the MFA process, solving the primary problem. Furthermore, the frequency of MFA challenges can be increased without incurring any further friction. Finally, this frequency can be increased until the process is completely continuous, without any interaction friction on the part of the user but eliminating or extending a session from the MFA security concept all together for continuous authentication.

Other inventions try to reduce friction by:
Reducing MFA frequency (once per session);
Making the MFA action required as simple as possible (swipe or check box);
Making the second factor device as portable as possible (CAC card);
Connecting the second factor device with the interaction device (USB key);
Using biometric sensors (fingerprint); or
Using device proximity alone

Other inventions improve security by:
Adding extra biometric or authentication steps (re-type password);
Increase MFA challenge frequency; or
Require MFA at login, and for using certain secure functions or applications.

Accordingly, there is a need for systems to improve MFA to overcome the foregoing issues.

### SUMMARY OF THE INVENTION

A convolutional deep neural networks to learn subject-specific features for each subject may be used to overcome obstacles in MFA. By using convolutional neural networks and a correct structuring of the learning task, this method allows an algorithm to find the optimal features for a specific subject. The advantage is two-fold. First, the need for a domain expert is eliminated allowing the search space to be algorithmically explored. Second, the features that allow each subject to be differentiated from other subjects may be used. This allows the algorithm to learn the aspects of each subject that make them unique, rather than taking a set of fixed aspects and learning how those aspects are differentiated across subjects. The combined result is far more effective authentication in terms of reduction of errors.

Determining the optimal features for a specific subject during biometric behavioral authentication finds optimal features in an automated fashion and finding those specific to the subject in question. It enables the algorithm to learn the specific aspects of a given subject that make them unique among all humans, rather than learning unique combinations of fixed features for that given subject. This approach eliminates the need for a feature or domain expert and improves biometric performance.

Further, BIMFA changes the paradigm of MFA by:
Making MFA completely invisible, so that friction is eliminated,
Fully continuous, so there is no session, and the system stays unlocked as long as the authorized user is in control, but instantaneously locks down when a change in control to an unauthorized user is detected.

Other solutions either sacrifice security for usability or sacrifice usability/convenience for security. Solutions that require extra hardware or devices for the sole purpose of authentication such as USB keys, RFID keys, and CAC cards, add an extra layer of friction to the user experience. These rely on proximity of the device or key alone and ignore the fact that the identity of the user may not be that of the authorized user. Often workarounds must be created for users that lose or forget these devices, which are immediately used by many more users who dislike that extra layer of friction. Theft or compromise of the device in conjunction with the password also results in total lapse of all identity security measures and unfettered access for the attacker. In many cases, adding biometric hardware is also a non-starter for usability and support reasons. For security-sensitive industries, any approach that reduces security further, such as longer MFA sessions, are unacceptable security risks for the minimal improvement in usability. Finally, solutions that allow MFA-free, or even password-less login using only proximity of another authorized and authenticated device, enable unfettered access to an attacker with only the compromised credentials of the second device and that device itself.

BIMFA improves security by eliminating a session and reacting continuously to the authorized user. It also removes the friction of MFA by not requiring the user to change anything about their workflow. Thereby, every action, regardless of risk level, is biometrically authenticated using something the user has, and is. Furthermore, because there is no session per se, if at any time during usage a change in control for the device occurs, the system can be instantaneously locked down, and revert to manual MFA. Finally, BIMFA, particularly the behavioral biometric aspect, prevents a breach even if the attacker has compromised multiple devices and passwords, even if they are able to defeat manual MFA. Using behavioral biometrics, the system can automatically recognize this situation, lock itself down and await the attention of an administrator.

### BRIEF DESCRIPTION OF THE FIGURES

The accompanying figures, where like reference numerals refer to identical or functionally similar elements throughout the separate views, together with the detailed description below, are incorporated in and form part of the specification, and serve to further illustrate embodiments of concepts that include the claimed invention and explain various principles and advantages of those embodiments.

FIG. 1 shows an exemplary system of items that comprise a system for implementing finding optimal features in an automated fashion during biometric behavior authentication.

FIG. 2 shows a plurality of components arranged to find optimal features in an automated fashion and find those specific to the subject in question.

FIG. 3 shows further structure of a deep neural network shown in FIG. 2.

FIG. 4 shows steps of training and deploying an authentication model.

FIG. 5 shows an exemplary system of items that comprise a system for implementing BIMFA.

FIG. 6 shows an overview of a layout of components illustrating an implementation of BIMFA.

FIG. 7 shows an exemplary method for effectuating BIMFA.

Skilled artisans will appreciate that elements in the figures are illustrated for simplicity and clarity and have not necessarily been drawn to scale. For example, the dimensions of some of the elements in the figures may be exaggerated relative to other elements to help to improve understanding of embodiments of the present invention.

The apparatus and method components have been represented where appropriate by conventional symbols in the drawings, showing only those specific details that are pertinent to understanding the embodiments of the present invention so as not to obscure the disclosure with details that will be clear to those of ordinary skill in the art having the benefit of the description herein.

### DETAILED DESCRIPTION

The foregoing descriptions, formulations, diagrams, and figures are provided merely as illustrative examples, and they are not intended to require or imply that the steps of the various embodiments must be performed in the order presented or that the components of the invention be arranged in the same manner as presented. The steps in the foregoing descriptions and illustrations may be performed in any order, and components of the invention may be arranged in other ways. Words such as “then,” “next,” etc., are not intended to limit the order of the steps or the arrangement of components; these words are used merely to guide the reader through the description of the invention. Although descriptions and illustrations may describe the operations as a sequential process, one or more of the operations can be performed in parallel or concurrently, or one or more components may be arranged in parallel or sequentially. In addition, the order of the operations may be rearranged.

### I. DETERMINING THE OPTIMAL FEATURES FOR A SPECIFIC SUBJECT DURING BIOMETRIC BEHAVIORAL AUTHENTICATION

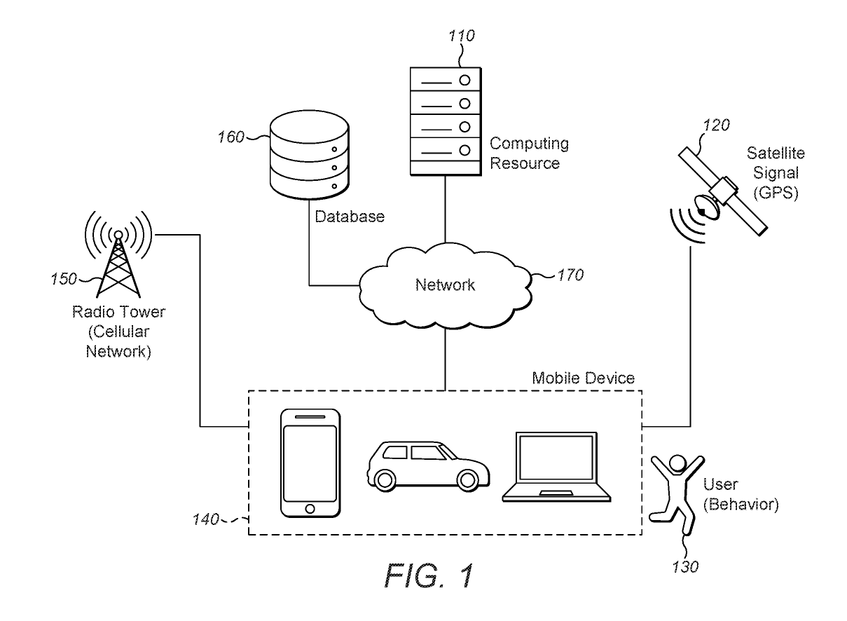

Turning to FIG. 1, shown is an exemplary system of items that comprise a system for implementing finding optimal features in an automated fashion during biometric behavior authentication. Shown is a user 130 whose behavior is being reviewed as he or she interfaces with a mobile device 140 (which may be a tablet, laptop, vehicle or the like). The mobile device 140 may use a cellular network 150 via a radio tower for connectivity and may use a satellite signal 120 for location via GPS. The mobile device 140 may also interface with a network 170, which may be in the cloud. The network may also interface with one or more databases 160 or other computing resources 110.

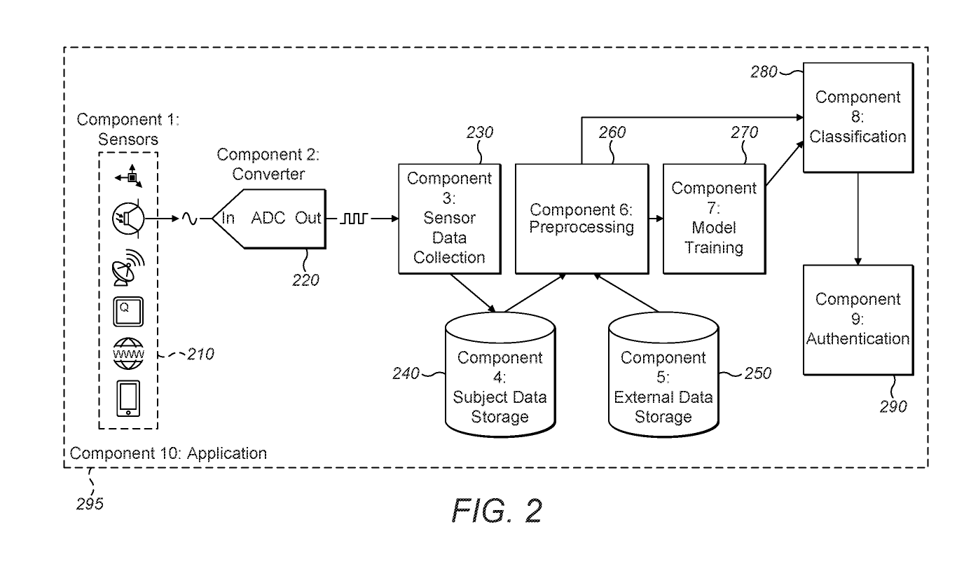

Turning to FIG. 2, shown are a plurality of components arranged to find optimal features in an automated fashion and find those specific to the subject in question.

Component 1 210 comprises sensors located on a device. Each sensor represents a specific instance of Component 1 210. A sensor is a piece of hardware or software that can observe a parameter of phenomena, either physical or digital in nature, and convert that parameter into a digital value. An example of a hardware sensor is a temperature sensor which is a resistor whose resistance changes with temperature in a predictable way. An example of a software sensor is a connector to a calendar application that can detect if a calendar event is present at the current point in time. Another example of a software sensor is a logical piece of code that indicates the type of transaction that a subject is executing, or the key that the subject is pressing. A sensor can be queried at any time, at which point an operation is executed which converts the observable phenomena into a digital or analog value and returns that value, either to the requesting unit, or an analog-digital converter (ADC, Component 2 220). A sensor may also fire as an interrupt, when a subject executes a specific task, when a condition is met, or when a key is pressed, etc. Also, sensors located on the device may also be able to sense remote phenomena, such as satellite signals (GPS), cell tower received signal strength (RSSI) or local weather information from an internet service.

Component 1 210 sensors are pieces of hardware (IMU, photodiodes, thermistors, etc.), software (calendar events, messaging notifications, etc.), and hardware/software (mouse or screen movements, key strokes, touch screen taps, presser, etc.) The sensors themselves can be purchased off the shelf and are delivered as part of a mobile, wearable or interactive device. The system must be built in such a way that each sensor can respond to a request for a measurement, or request for continuous periodic measurements, and implement a cancellation of those requests.

Component 2 220 comprises a converter. This component may be used to allow the use of non-digital sensors (Component 1 210). For example, hardware sensors may require analog-to-digital converter (ADC) that consumes the analog output of the sensor (a voltage level) and converts that into a digital representation for that value (e.g. a number and range). It may also perform further operations to convert the number into a specific set of units, such as degrees Celsius or meters per second squared or G's. For digital sensors that can be system API's, an example would be a software module that queries the calendar API at any given time and returns true if an event is present or false otherwise. This module connects to the sensors (Component 1 210) for input, and outputs to Component 3 230.

As an Analog to Digital Convertor (ADC) converter for analog sensors, Component 2 220 takes an analog amplitudinal signal and converts it into a digital value. The ADC is a hardware or software component that converts analog or digital information coming from a sensor into digital readings consumable by a hardware or software entity. A simple example is a software calendar adapter that takes the current time and a list of events and times and returns true if there is an event at this time, false otherwise.

Component 3 230 comprises a sensor observation engine that collects data from device sensors. This component controls sensors and periodically samples them. Specifically, this component periodically reads values from sensing units in Component 1 210. This component is constructed by using an internal timing mechanism of the computation hardware. For each sensor frequency is set (either statically or dynamically based on system or subject behavior). When the period defined by that frequency expires, the value is read from the sensor, either directly or using an ADC. Each measurement is appended to the exact time at which it was recorded and added to the pool of data. For interrupt sensors, the sensor hardware/software channel is monitored, and on reception of an event, that event is logged in the stream with all relevant metadata appended.

The period with which values are read may be static or dynamic. When each observation is collected, the time at which it was collected is noted and appended to the value read, creating a time-series of values of the phenomena that the specific sensing unit is capable of reading. For interrupt sensors, this component listens to and records them in time series of their own, adding time stamps and meta information if necessary. The output of this component is a time-series for each sensor connected to the system. This component is connected to one or more sensor units (Component 1 210). This component may be connected to Component 1 210 through an analog/digital converter (Component 2 220). This Component outputs to Component 4 240 to store the data of this specific subject.

Component 4 240 comprises subject data storage. This component stores and provides access to current and historical data from the subject at hand. Specifically, this component is a persistent data storage that contains all observational information on the authorized subject, i.e. the current subject. This information may contain, but is not limited to, sensor observations, timestamps, subject annotations, environmental information or observations such as weather or location annotations, device information, device contexts, application information, application transaction information, subject characteristics, subject identifying information (PII), financial information, and any other information that pertains to the subject, their device, their behavior, or has correlative or causal relationships with any of the above data. It also contains an identifier (ID) unique to this subject.

This component can be built using any persistent storage hardware and database software. The data is structured and can easily be stored in a SQL database such a PostGres. Each subject is assigned an ID, and all measurements pertaining to that ID. Each measurement type has its own table, linked to the ID of the sourcing subject, with the timestamp of that observation and any other required meta information.

Component 5 250 comprises external data storage. This component stores and provides access to historical data from other subjects. This component is similar to Component 4 240 while containing the subject data of other subjects, not including the current subject. This component is constructed in the same way as Component 4.

Component 6 260 comprises data preprocessing. This component takes physical sensor observations and prepares them for the processing algorithm. This component consumes streams of sensor observations and the associated time stamp for each measurement. This component can process data in real time, and to process previously collected data. First, the data is cleaned by resampling to a constant and consistent sample rate across all sensors, interpolating missing measurements. Using a sliding window technique, the data streams are cut into windows of length WL by subject. Each window contains all sensor observations for all sensors in the given time frame and is labeled by the ID of the subject that generated the data. The set of these windows is the preprocessed data. Finally, windows containing irrelevant information are discarded.

This component can be constructed as database queries over Components 4 240 and 5 250. The queries take a subject ID a timestamp, and window length as input. The queries return all sensory data pertaining to that subject, with a timestamp after the specified timestamp, and before the time obtained by adding the window length to the timestamp. The timestamp is then increased, and the process is repeated until all required data has been retrieved. The data is then resampled to a fixed sample rate, for example using hold resampling, and any missing data points are estimated, for example using linear interpolation. The resulting data is then output as a tensor, where the columns are the timestamp followed by a column for each sensor, and the rows are the observations of the sensor at the stated timestamp. The windows may be set back-to-back, but may also contain overlapping information, obtained by increasing the timestamp variable by the window length, or by a fraction of the window length respectively. This component may or may not perform further data processing such as resampling, normalization, interpolation or translation into different domains, e.g. time or frequency domains.

Component 7 270 comprises model training. This component consumes data from the current subject and external subjects. Using the preprocessed windows from Component 6 260, a model is built that learns subject-specific features. First, data windows are segregated by subject into two sets: one set containing data of the current subject, and one set containing data from external sources (other subjects). The goal of this component is to generate a module that can distinguish data windows of the current subject from data windows of all other subjects and do so by learning features (signal characteristics) of those windows which are unique to the current subject. To achieve this, a deep neural network with a convolutional component is used. Alternatively, a feature learning module may be used to learn the best features to distinguish a specific subject from other subjects.

To construct this component there are several deep learning tools that can be used, such as TensorFlow, MXnet, Keras, Lasagne, etc. Each window output by Component 6 260 represents a single multi-dimensional input vector for the constructed neural network. To create a model which will learn subject-specific features, one or several convolutional neural network layers are constructed, followed by one or several dense or fully-connected layers, followed by a SoftMax layer which converts the value inputs into a classification output. The convolutional layers are constructed using filters or kernels, where each filter has a length significantly less than the length of the window.

To construct this component there are several deep learning tools that can be used, such as TensorFlow, MXnet, Keras, Lasagne, etc. Each window output by Component 6 260 represents a single multi-dimensional input vector for the neural network constructed herein. To create a model which will learn subject-specific features, one or several convolutional neural network layers will be constructed, followed by one or several dense or fully-connected layers, followed by a SoftMax layer which converts the value inputs into a classification output. The convolutional layers are constructed using filters or kernels, where each filter has a length significantly less than the length of the window.

Assuming a window length of 100 seconds and a sample rate of 1 Hertz for all sensors, an accelerometer (3 axes) and a temperature sensor (thermistor), and a filter length of 10 second, a reference architecture, consisting of 3 convolutional layers, 2 dense layers, and one SoftMax layer will be described.

Convolutional: Each filter would consist of 10 weights (10 measurements in 10 seconds at 1 Hz) by 4 weights (4 sensors). They are passed across the window offset by one measurement, or 1 second, until a filter contains the most recent measurement in the window, for a total of 5*91*4 output values. The number of filters used can be arbitrarily set, or in this case 5. The resulting output of each filter is an activation map which represents the input for the next layer. This represents one convolutional layer. On top of this layer, the same method is repeated. 5 more 10×4 weighted filters are applied again to the output of the first layer, offset by one for a total of 5*82*4 output values. Repeated again, the third layer contains 5*73*4 output values generated by 5 10×4 filters.

Flattening: Between the convolutional and fully-connected layers is a flattening operation that converters the multi-dimensional output values into a 1-dimensional array.

Fully-Connected: The first dense layer is created on top of the flattened output of the third convolutional layer, where every neuron in the dense layer takes the output of every value generated by the top convolutional layer as input. For the reference, the dense layers can be assigned 100 weights each. On top of this is another dense layer with 100 weights.

SOFTMAX: Finally, a SoftMax layer, consisting of a perceptron with 1000 input neurons, fully connected to a single output neuron is constructed, which converts the dense layer output values into a single estimation value.

In deep learning shorthand the reference architecture is defined as the following:

### C(5)-C(5)-C(5)-D(100)-D(100)-Sₘ

where C(i) is a convolutional layer with i filters, D(j) is a dense layer with j weights, and Sₘ is a SoftMax layer.

To train the network, backpropagation is used using stochastic gradient descent (SGD). The aforementioned platforms support the implementation of this process. Training labels are generated using the ID labels for each window for the selected subject. The labels are binary, and the generated label is 1 if the window ID is the ID of the selected subject, and 0 otherwise. The windows are then fed through the network, which is trained to reduce the error of estimating the labels. SGD is used to correct that error, and backpropagation applies that correction to the weights in the network. The combined effect of this is that the filters in the convolutional layers of the model learn features to solve the identity problem that are specific to this subject in identifying and differentiation them from all others.

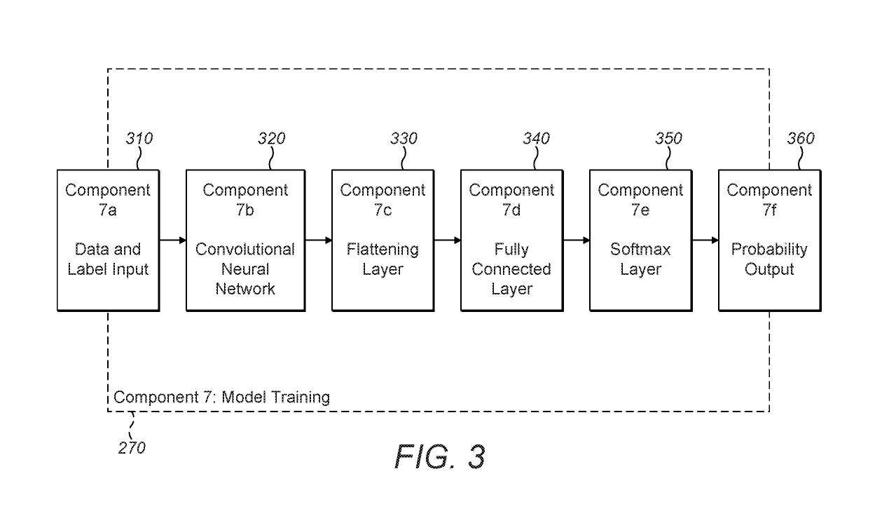

The structure of this deep neural network is shown in FIG. 3 and is as follows. At the beginning of Component 7 270, data input is provided a window at a time by Component 7a 310. A convolutional neural network models subject-specific features in Component 7b 320. This data is flattened by Component 7c 330. A fully-connected neural network maps those features to the subject in Component 7d 340. A SoftMax layer (regression) uses those mappings to make a prediction in Component 7e 350, which is then converted to a probability that the given window was generated by the current subject in Component 7f 360.

To train this model, subject IDs are converted to binary labels. For the current subject, their subject ID represents the positive class and is represented as a label with a high value, e.g. 1. For all other subjects, their labels represent the negative class and are represented as a low number, e.g. 0. All labeled data is then segregated into 3 containers of training data, evaluation data, and test data. The training phase is done in epochs. Training data windows are passed through the network, and the output is compared to the label of that window to compute the error. Using that error, the network is corrected using backpropagation and an optimization algorithm such as stochastic gradient descent (SGD). Performance is then evaluated using the evaluation data set. Finally, the test data is used to prevent overfitting by ensuring that optimizations done on the evaluation data in each epoch are not negatively affecting performance on separate data sets.

This process is then repeated for each subject. By creating new sets for each subject and allowing the convolutional network to learn different characteristics for each subject individually, subject specific features can be achieved, drastically improving performance.

Returning to FIG. 2, component 8 280 comprises classification. This component consumes current observations from the subject and a trained model and outputs an indicator of whether that data fits the current model. In this component, a model trained by Component 7 270 is used for authentication. Preprocessed data windows gathered from the subject are passed to the classification component which outputs a probability that they were generated by the current (authorized) subject.

This component uses the subject-specific features and model created in Component 7 270 to authenticate the subject. With the same platform used to create the model, current data generated by the subject is passed through the model in a feed-forward fashion.

Component 9 290 comprises authentication. This component computes a binary authentication, probability, confidence and/or binary decision about whether the current subject is authenticated based on their behavior. For the given business case, the probability output by Component 8 280 is converted into a decision or risk score which is delivered to the application (Component 10 295). This could be a threshold-based decision, or a binary one, depending on the use case and eventually cost-benefit analyses for the business case of false positives versus false negatives.

This component provides the information about the matching of the current behavior to the modeled behavior from Component 8 280 to the application (Component 10 295). Either the application makes the authentication decision to grant or revoke access, in which case a raw probability and/or confidence value is provided directly, or Component 9 itself makes the decision and provides that to the application. For a reference implementation, the soft output of Component 8 280 between 0 and 1 is passed through a threshold to arrive at a hard decision, for example >0.5 is set to authenticate, where <=0.5 is not authenticated.

Component 10 295 comprises an application. The application consumes the authentication signal and is a piece of software or hardware that enables the subject to accomplish a task. It may handle the authentication itself and passes the initial state to Component 8 280 once that process has been completed. From then on it relies on the output of Component 8 280 to deduce if the subject is allowed to continue or conduct certain actions that require authentication. Several parts of the application may be accessible with or without a valid authentication session.

The application is a hardware or software service that enables the subject to complete a task that requires some level of security, for example to transfer funds from their bank account.

The above components relate to each other via data connectivity. Components may be on the mobile device itself using local computation and storage, using local hardware to enable connectivity between modules. Alternatively, they may be located remotely using network computation and storage (see FIG. 1). All of Components 1 through 9 are either part of an application (Component 10) or are provided as a service to Component 10.

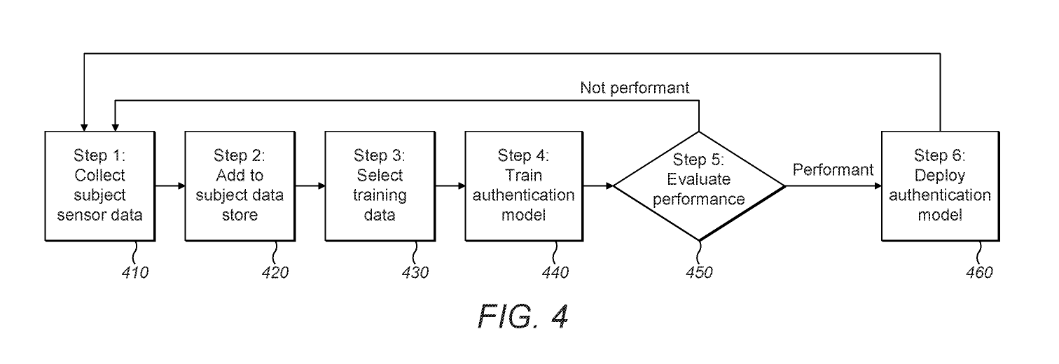

Turning to FIG. 4, shown are the steps of training and deploying an authentication model.

In step 1 410, Component 3 230 may be used to collect data from Component 1 210 (Sensors) via Component 2 220 (ADC), and the measurements may be stored in Component 4 240 (subject data storage).

In step 2 420, data is added to the subject data store.

In step 3 430, a training data set is created by drawing on Component 4 240 and Component 5 250 (external data set from other subjects).

In step 4 440 a model is trained using Component 7 270 (7a-7f, 310 320 330 340 350 360 model training).

In step 5 450, f the model is performant proceed to Step 6 460; if not performant proceed to Step 1 410.

In step 6 460, the authentication model is deployed.

Should performance be deemed insufficient for the use case in Step 5 450, the system reverts to Step 1 410 and continues training until the model performance passes. After deployment, training may be continued as well.

The foregoing systems and methods may be varied in numerous ways.

A. The subject and external data stores may be separate or together in a single storage unit.

B. One could use a principle component analysis or an independent component analysis instead of convolutional networks to obtain subject dependent features.

C. One could construct the network without any preprocessing, passing live data directly into the network.

D. Similarly one could conduct training live without having a subject data storage.

E. One could use a subset of either subject data or external data in the training process, or both.

F. One could use rectified linear units (RELU) to add non-linearity to the output.

G. One could use MaxPooling between layers to reduce model complexity and overfitting.

H. The number of convolutional and fully-connected layers used can be increased or decreased.

I. Recurrent nets such as long-short term memory networks (LSTM) can be used in place of, or in addition to, the fully-connected layers

J. Generative adversarial networks (GANs) can be used alongside the presented model structure to improve model performance.

K. Pretraining can be implemented by training the model used on the same or a similar data sets and classification problems to speed up training and improve performance.

L. Encoders, Decoders, and ladder networks can be used to speed up learning with less data.

M. In the reference architecture, 2-D filters are used across time and all sensor streams in parallel. It is also possible 1-D filters where each filter convolves across time but only across a single sensor stream.

N. RMSProp, ADAM can be used instead of SGD.

O. Each of components 3-9 230 240 250 260 270 280 290 can either be located locally or on a remote server.

P. Instead of using all data for training, data can be split into three pools, training data, validation data and test data. Validation data is used to evaluate when to stop training to prevent overfitting, and test data to estimate real performance. Optimally, these sets should be selected from chronologically contiguous segments instead of at random as proposed.

Q. Any component, or combination of components, can be located locally to the sensing device, or on a different device, e.g. a cloud location.

R. The sensing device and the device running the application may be separate devices.

S. Component 9 290 may be used as input for another security or identity module and not directly feed to the application.

T. After implementing the subject-specific training procedure, the system is integrated into an application, consuming observations in-near real time and outputting an indication that the current subject is the authorized subject. In this way, the authorized subject must only be prompted to identify themselves in the case where the behavioral authentication outputs a confidence less than the level of assurance needed by the application. In this way the subject experience is improved. The security of the application is also enhanced as a change in control can be identified instantaneously.

U. Subject specific features could be used to identify specific subject behaviors with greater accuracy than generalized features.

V. This method also creates higher inter-subject model diversity and divergence, enabling model-based distance metrics for cross-device matching.

W. This approach may also be used in combination with another biometric to improve performance.

X. This may also be used with mobile facial recognition, both to improve performance and as a form of liveness detection.

Y. Subject-specific features improve the accuracy and performance of the authentication models.

### II. BEHAVIOR-BASED INVISIBLE MULTI-FACTOR AUTHENTICATION

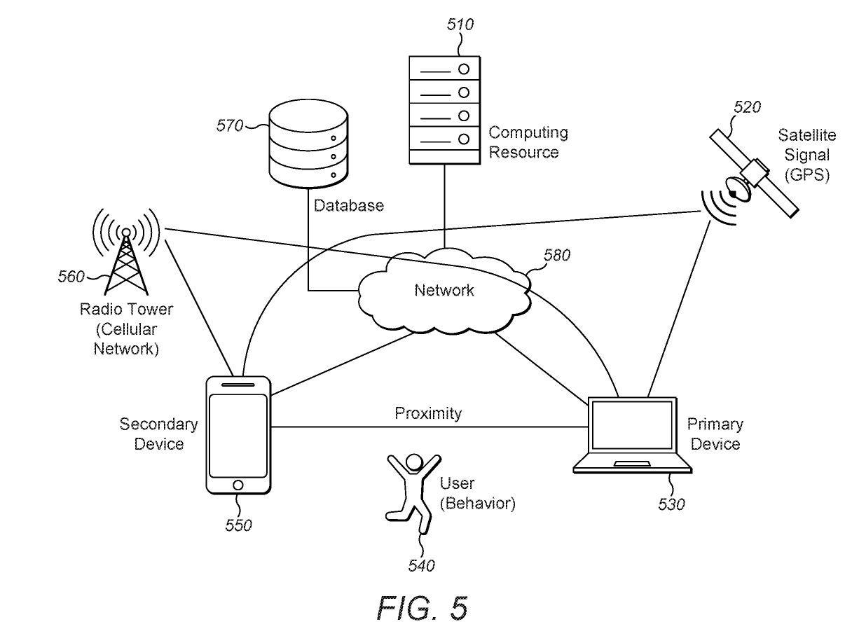

Turning to FIG. 5, shown is an exemplary system of items that comprise a system for implementing BIMFA. Shown is a user 540 who is proximate to a primary device 602 and a secondary device 606. The primary device 602 and the secondary device 606 may use a cellular network 560 via a radio tower for connectivity and may use a satellite signal 520 for location via GPS. The primary device 602 and the secondary device 606 may also interface with a network 580, which may be in the cloud. The network 580 may also interface with one or more databases 570 or other computing resources 510.

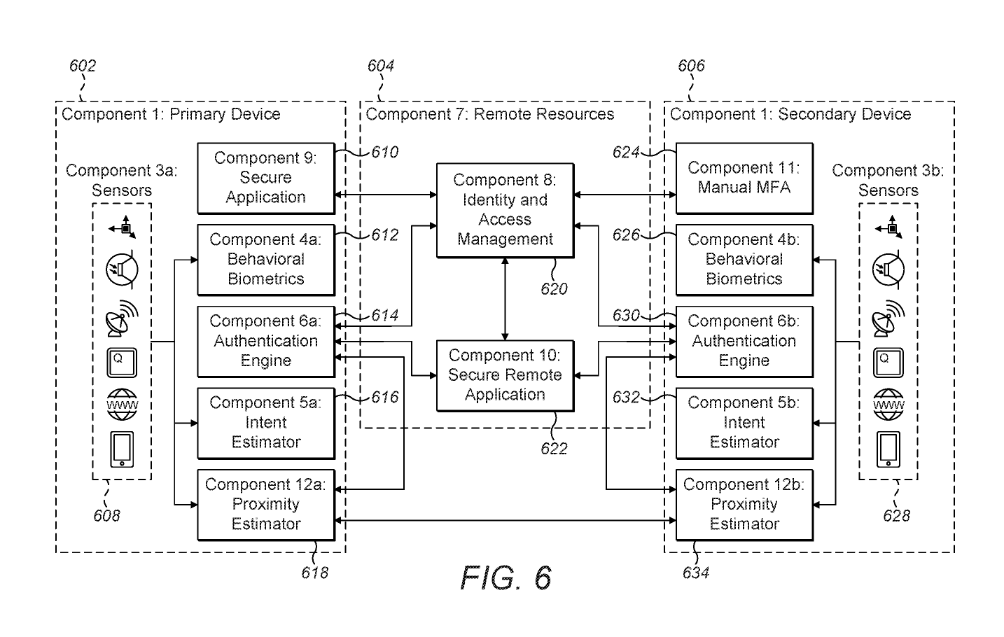

Turning to FIG. 6, shown is an overview of a layout of components illustrating an implementation of BIMFA.

Components on the same devices are either software or hardware components that communicate with each other using hardware or software buses, interrupt lines, APIs etc.

Remote components are accessed using wired or wireless data connections. Primary devices 602 and secondary devices 606 may communicate with each other through the internet, intranet, a remote proxy, or in a peer-to-peer fashion using Bluetooth, NFC, Wi-Fi, ZigBee, etc.

Component 1 is primary device 602. This is a device that the user 540 interacts with to accomplish a task using an application (Components 9 610 or 10 622). It may have some form of user interface, such as a touchscreen, screen, keyboard, mouse, touchpad, motion sensor, etc. to help the user accomplish this. The device may be a mobile device such as a smart phone, a wearable device like a smartwatch, a portable device like a laptop, a fixed device like an ATM or desktop workstation, a smart car, a smart door lock, etc.

Component 2 is a secondary device 606 which the user has with them, carries on their person, wears, and/or interacts with. This device has a similar description and components as the primary and may also contain applications. In this case however, it contains an MFA application that challenges the user 540. This challenge is something that ensures that the user is in control of the secondary device, and that they intended to access the application on the primary device. This could be as simple as requiring the user 540 to unlock the secondary device, and press a button in the manual MFA application, but could also present a one-time passcode that the user must enter into the primary device (Component 1 602) or secure application (Components 9 610 or 10 622). It may also require the user to manually biometrically identify themselves.

Components 3a/b 608 628 are sensors located on a device. Sensors are pieces of hardware (IMU, photodiodes, thermistors, hygrometers, barometers etc.), software (calendar events, messaging notifications, app usage sensors, account balance measurements, etc.), and hardware/software (mouse or screen movements, keystrokes, touch screen taps, pressure, etc.), audio sensors of ambient noise, user voice, ambient voices and sound, etc., cameras for video of the user, their environment, face, body, field of vision, eyes or other features.

Each sensor represents a specific instance of Component 3a/b 608 628. A sensor is a piece of hardware or software that can observe a parameter of a phenomena, either physical or digital in nature, and convert that parameter into a digital value. These sensor values measure parameters that are influenced by user behavior, or the environment, or aspects that may correlate with specific user behaviors. An example of a hardware sensor is a temperature sensor which is a resistor whose resistance changes with temperature in a predictable way. An example of a software sensor is a connector to a calendar application that can detect if a calendar event is present at the current point in time. Another example of a software sensor is a logical piece of code that indicates the type of transaction that a subject is executing, or the key that the subject is pressing, or the movement of a mouse pointer or other input device. A sensor can be queried at any time, at which point an operation is executed which converts the observable phenomena into a digital or analog value and returns that value, either to the requesting unit, or an analog-digital converter. A sensor may also fire as an interrupt, when a subject executes a specific task, when a condition is met, or when a key is pressed, etc. Also, sensors located on the device may also be able to sense remote phenomena, such as satellite signals (GPS), cell tower RSSI or local weather information from an internet service. It may also query network status, such as the ID of the current connectivity access point or network controller or query the IDs of surrounding networked devices (e.g. Wi-Fi, Ethernet, IP, etc., or P2P such as Bluetooth, NFC, ZigBee, etc.) that are visible. Sensors may also contain an active component that emits a signal on one device which can be received by a corresponding sensor on another device, and then analyzed for characteristics such as time of flight, signal strength, etc., or even informational content encoded on that signal. It is also possible for these signals to use digital media such as inter- or intranet connectivity for communication, but also physical media, such as space, air, water, etc.

Components 4a/b 612 626 are behavioral biometrics. These components consume behavioral observations of the user using sensors (Components 3a/3b 608, 628), and, with the help of a behavioral model, make an intuitive decision about whether the observed behavior is generated by the authorized user. This model may be an expert system or built using machine learning given a history of behavioral observations from this user and other users. These components run continuously and can be queried at any time.

Further, this unit consumes observational data from the sensors (Components 3a/b 608 628) by continuously querying these sensors for information, subscribing to the sensors, or listening for interrupts. It then builds a model of the behavior of the authorized user. For this purpose, a history of sensor/behavior observations are required, as well as labels that confirm that these were generated by the authorized user. Identity labels can be gathered by challenging a user with traditional authentication methods, or by listening passively for authentication for other purposes, such as subscribing to on-device biometrics that control log in, or simply by assuming (or manually confirming) that only the authorized user has access to the device during data collection. Using this data, a model that describes that data can be created. For example, one could fit a multidimensional Gaussian mixture model to that data, which outputs a high probability if a given sample is similar to the observed historical data, and a low probability otherwise. Then, given the constraints of the scenario, a threshold can be selected that, for a given probability, decides if it is high enough for authentication. This module can either output a probability, or a binary indicator, or some other piece of information that either indicates that the user is authenticated or allows another module to make that decision. Then, continuously or at authentication time, current or immediately precedent data can be passed through the model to give an authentication result at any time, without requiring effort on the part of the user. Alternatively, an expert system could be built, for example using IF THEN statements, that outputs a yes or a no for observed behavior using knowledge of the authorized user. This approach can either be tested using historical data or may require no historical data at all.

Components 5a/b 616 632 are intent estimators. These components also consume sensor data (Components 3a/3b 608 628) and using a model, estimate if the current action taken (i.e. the action requiring authentication) was indeed the intended action by the user. This model may be an expert system or built using machine learning given a history of behavioral observations from this user and other users.

Further, this component consumes sensor data and can be built in much the same way as Components 4a/b 612 626, with the difference that behavior is only collected during points in time when the user is known to intentionally conduct the action with the application (Components 9/10 610 622) that is being authenticated. The same modeling approach would output a high value, or a positive value, if the user is intending to do that action, i.e. log in, or open a VPN client. This model may be built such that it is identical for all users, and not necessarily user-specific.

Components 5a/b 616 632 may work collaboratively in a peer-to-peer fashion, remote proxy, or internet connectivity to establish intent.

Components 6a/b 614 630 are authentication engines. This component consumes the estimation of intent (from Components 5a/b 618 632), and the estimation of authentication (from Components 4a/b 612 626), and the estimation of proximity (from Components 12a/b 618 634) and fuses these pieces of information to decide about whether the current action is authenticated or not. This model may be an expert system or built using machine learning given a history of behavioral observations from this user and other users. This component can either be triggered by a local application (Component 9 610), a remote application (Component 10 622), or a remote identity and access management (IAM) system (Component 8 620). The IAM may also be known as a behavioral authenticator. It may also simply enforce the decision which may be made remotely, for example by Component 8 620.

Further, these components consume the outputs of Components 4a/b 612 626, 5a/b 616 632 and 12a/b 618 634 respectively, communicate with Component 8 620 about the access permissions and policies, and implement and enforce access or revocation of access for the user to the application (Components 9, 10 610 622), either directly or by communicating the authentication decision to the IAM (Component 8 620). This component can be built as a software module that locks the screen or application window if access is not granted and may trigger Component 11 624 to implement a manual MFA challenge via Component 8 620. A straightforward and simple implementation would be to create three upper thresholds for authentication, one each for Components 4a/b 612 626, 5a/b 616 632 and 12a/b 618 634, on each device respectively. If the scores for each are above their respective thresholds, the user is deemed authenticated and access is granted (Step 7 770). If either is below the threshold, the status of the user's authorization is deemed unknown and manual MFA is invoked (Step 9 790). Then 3 more lower thresholds can then be used, where below these thresholds, the user is deemed to be unauthorized with certainty and the system is locked until unlocked by a system administrator (Step 10 795). These Components 6a/b 614 630, but especially Component 6a 614, may continuously (or nearly continuously) query Components 4a/b 612 626, 5a/b 616 632 and 12a/b 618 634 for the authentication state of the user, and independent of the user's actions, trigger a manual MFA, a BIMFA action, or simply terminate access. The decision to require MFA or BIMFA, and the confidence threshold values, can be governed by Component 8 620.

Component 7 604 are remote resources. This component contains remote processing units, memory units, applications and components that can be hosted on the local network, internet, server or cloud. These resources are not necessarily co-located and may be fundamentally different from each other, aside from the fact that they are remote from Components 1/2 602 606.

Further, this component contains remotely accessible resources. It may be on a local machine, on Components 1 602 or 2 606, on a server, internet or cloud, and may be accessible via P2P communication, intranet, internet or other forms of communication.

Component 8 620 is Identity and Access Management (IAM). This is a standard module that governs access policies, user identities, providing the decision if a certain action requires authentication, and how severe that authentication needs to be for a user-action tuple, including if manual MFA or BIMFA is acceptable.

Further, this component manages the identities of authorized users, as well as access control policies. It can trigger both BIMFA and manual MFA authentication events, and coordinate actions between primary and secondary devices.

Component 9 610 is a Secure Application. This component is a software or hardware tool that allows a user to accomplish a task. For example, this could be a VPN application that allows the user to connect to a secure network. This component is part of the workflow of the user on the primary device which they are using to accomplish some task. Access to this application is governed by the IAM unit (Component 8).

Component 10 622 is a Secure Remote Application. This component is a software or hardware tool that allows a user to accomplish a task that is remotely located. An example could be an intranet website that lists all investors and their contact info for the company. This application would be accessible through an API, a browser, or some other form of remote access. The user may be accessing a remote application from their primary device that serves a similar role to Component 9 610.

Component 11 624 is a manual MFA component, which is already accessible on most devices, such as an “Authenticator” app. This is a standard module that challenges the user and requires the user to perform a manual task (work) that ensures that the user is in control of the secondary device, usually through a one-time password or a biometric, and has the intent to perform the action that is being authenticated.

Components 12a/b 618 634 are designed to give the best possible estimation of the distance between the primary and secondary devices. A simple instantiation of these would be to generate a range in units of physical distance from each other, for example using RSSI from a share wireless communication channel or shared access point, or virtual distance from a shared IP address or network controller. Some communication modules implement this off the shelf, such as Bluetooth Low Energy SoCs. In the presence of the correct emitter-receiver setup, one could also implement ranging by emitting a signal on one device, and using the RSSI on the other, combined with knowledge of the communication channel and a time-of-flight measurement to estimate physical or digital distance. This component can use a single source that implements ranging and possibly perform some denoising or use many sources and fuse the inputs for best results.

Further, these components consume sensor data (Components 3a/3b 608 628) and using a model, estimate proximity between primary and secondary devices (Components 1 602 and 2 606) (i.e. the distance between them). This model may be an expert system or built using machine learning given a history of behavioral observations from this user and other users, or simply a module that uses sensors designed specifically for ranging. The output of these components is passed to the authentication engines (Components 6a/b 614 630).

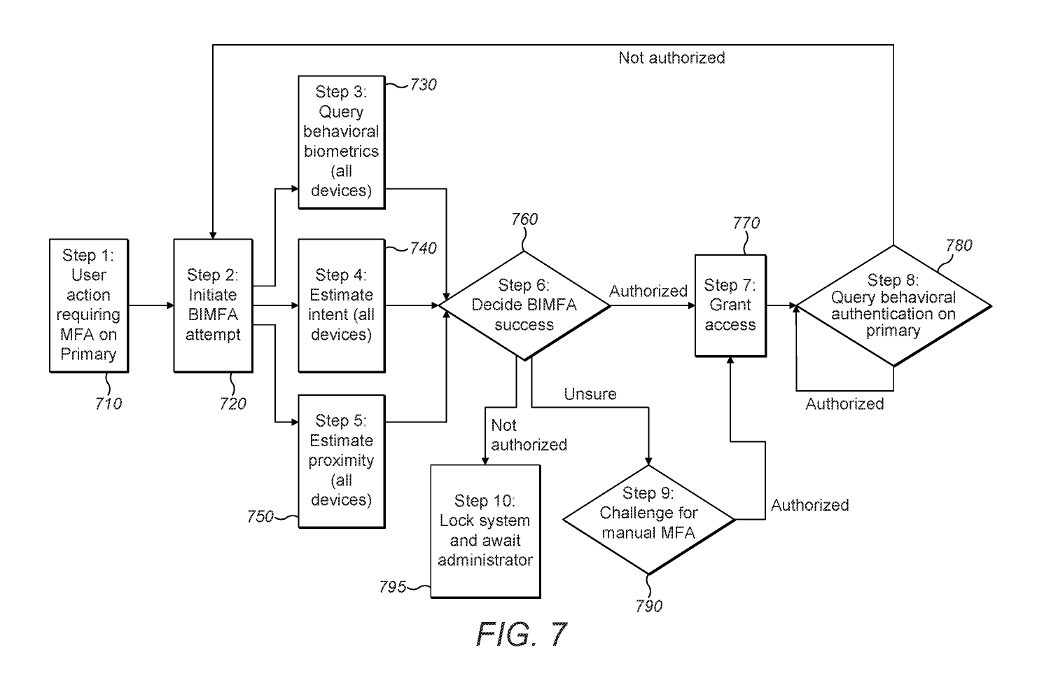

Turning to FIG. 7, shown is an exemplary method for effectuating BIMFA.

In step 1 710, the user performs a secure action on the primary device, such as logging in or starting interaction with a secure application.

In step 2 720, the process is initiated to evaluate the current conditions for BIMFA.

In step 3 730, the behavioral biometrics state on the primary and secondary devices (Components 1/2 602 606) is queried from Components 4a/b 612 626 as to the user's authentication state to ensure that they are in control of the devices.

In step 4 740, the primary and secondary devices estimate the belief that the action being authenticated was indeed the intention of the user using Components 5a/b 616 632, i.e. it was the user of the secondary device that wished to execute the action on the primary device.

In step 5 750, both devices (Components 1 602 and 2 606) collaboratively (or unilaterally in parallel) estimate their proximity to each other using Components 12a/b 618 634.

In step 6 760, based on the outputs of Steps 3 730, 4 740 and 5 750, Components 6a/b estimate the confidence that this action can be authenticated using BIMFA. If the Components 6a/b 614 632 decide that this action is authorized, the process proceeds to Step 7 770. If the decision is that the action is not, the process proceeds to step 10 795. If there is no certainty, the process proceeds to Step 9 790.

In step 7 770, the user is allowed to proceed and access is granted.

In step 8 780, the authentication state of the user is behaviorally established after access is granted on the primary device. This step repeats indefinitely until the user has completed their task, or their usage of the device, or until it is established that the user's behavior does not match that of the authorized user, at which point the process proceeds to Step 2 720.

In step 9 790, a challenge for manual MFA is triggered and the user must manually authenticate and demonstrate intent. If this succeeds, the process continues to Step 7 770, otherwise the next step in the procedure is governed by the IAM policy from Component 8 620. A good policy may be to return to Step 9 790 on failure 3 times, and after 3 failed attempts the process transitions to Step 10 795 (not shown in FIG. 7).

In step 10 795, authentication has failed, the user access to the secure application or action is blocked and the status is logged and flagged for the administrator. The system is locked down until the administrator responds.

The logical flow in FIG. 7 may be summarized by a positive path, and a negative path.

The positive path successfully authenticates the user using behavioral biometrics to establish authorized control. It then establishes that the authorized user on the secondary devices intended to perform the action that required MFA on the primary device. It then establishes that the devices are proximate to each other. It then behaviorally authenticates the user on the primary device. It then allows the user to continue with that action and continually authenticates the user using behavioral biometrics at any time.

The negative path occurs should BIMFA fail. Here, the system reverts to manual MFA. If that failure is not resolved, the action is prevented and the challenge is repeated. If the authorized user resolves the challenge, the action is allowed and the user proceeds with continual behavior-based biometric authentication.

The foregoing system may be implemented in various ways.

To begin with, two or more devices are required that will be secured, or used to access local or remote secure applications. On each device a software module is deployed which will contain Components 4a/b 612 626, 5a/b 616 632, 6a/b 614 630, and 12a/b 618 634. Components 1 602, 2 606, 9 610, 10 622, and 11 624 are considered to be pre-existing.

Components 3a/b 608 628 are most often delivered with the device. Further sensors, such as digital sensors, can be implemented by periodically querying other applications and device attributes, such as the presence of a calendar event, or the device ID, the addresses and signal strengths of all visible networks, etc. These can then either be stored locally or passed via callbacks in real time to Components 4a/b 612 626, 5a/b 616 632 and 12a/b 618 634.

Components 4a/b 612 626 are constructed be collecting the sensor measurements from Components 3a/b 608 628 and recording them, either to persistent or fleeting memory, either on the device or to a remote resource (Component 7 604). Using this store, either locally or remote, they then fit a model that describes the data, for example using an implementation of a Gaussian Mixture Model for a library, such as sci-kit learn. Once the model has been trained, deploy the parameterized object to Components 4a/b 612 626 and implement a method that can execute that model for a log likelihood given data observations. A simple way to do this is to train the model using data from other users to give a likelihood of 0 for other users, and a likelihood of 1 for the current and authorized user as a binary classification problem. In this way, the log likelihood can be converted to a probability between 0 and 1 for a given vector of observations. Now, for this Component to run, real time observations from the sensors are passed as input to the model, which then outputs a number between 0 and 1, indicating at that moment in time, what the probability is that the authorized user is in control of the device. This number is then the output that is then passed to Components 6a/b 614 630 and 8 620.

Components 5a/b 616 632 Intent estimators can be constructed in much the same way as behavioral biometric components 4a/b 612 626. Behavioral observations are collected and recorded, but in this only those observations immediately preceding secure actions. Then a model is built for each secure action, that differentiates that behavior from other behavior. In this way that model can be deployed to output a higher probability when the authorized user is intending to execute a secure application, and a low probability otherwise. For example, if a user accesses a VPN only while at their desk, access will be prevented if an attempt is made while they are walking to the bathroom.

Components 6a/b 614 630 can be built simply by querying Component 8 620 to verify that the account for this user is authorized to access Components 9/10 610 622 and uploading to Component 8 620 the local output of Components 4a/b 612 626, 5a/b 616 632, and 12a/b 618 634. Then, using local and remote estimations of intent from Components 5a/b 616 632, provided by the local component and remotely by Component 8 620. respectively, decide if these are above the threshold for intent that can be set either locally, or delivered as a policy from Component 8 620. The same then applies for the output of Components 12a/b 618 634. Then using local and remote estimations from Components 4a/b 612 626, 5a/b 616 632 and 12a/b 618 634, another threshold that can be set locally, or remotely by Component 8 620, can be applied to these values. This yields a decision about whether intent estimation, behavioral biometric information and proximity are sufficient to execute BIMFA. For example, on the primary device (Component 1 602), if the user attempts to open the VPN application which is deemed secure by Component 8 620, if range is less than 1.5 meters to the secondary device (Component 2 606) is measured, and behavior establishing intent is observed, and Component 6a/b has deemed that the user is authenticated on Components 1/2 602 606, then conditions have been met for BIMFA and the user is granted access. At any point, should the behavioral biometric components for both devices (Components 4a/b 612 626) both indicate that this is not the authorized user, Component 11 624 can be used to challenge the user through manual MFA, otherwise the system can be locked until it is unlocked by an administrator. However, this is threshold approach is a very simplistic method. A better way is to collect data of the inputs (Components 4a/b 612 626, 5a/b 616 632, 12a/b 618 634 outputs) for authorized and unauthorized users and train a model that predicts the correct output (i.e. if for these inputs, successful BIMFA is the best outcome). In this way, Components 6a/b 614 630 fuse and denoise the inputs to arrive at the most accurate possible results.

Component 7 604 Remote Resources can be constructed by purchasing a server and connecting it to a network location reachable by the primary and secondary devices.

Component 8 620 IAM can either be constructed manually using a database and software application that contains and implements the list of authorized users and passwords, as well as access control policies dictating which accounts are authorized to perform which actions. These can be queried using APIs. This module can also be purchased from providers such as Okta, Duo, Microsoft Active Directory, etc.

Component 9 610 Secure application on the primary device can be created by installing a standard email client.

Component 10 622 Secure Remote Application can be constructed as a website that allows the user to view the contents of the Component 8 620 database and requires the user to submit a user name and the corresponding password correctly to view the page, as well as requiring MFA for access.

Component 11 624 Manual MFA Authenticator A simple implementation would be an app that responds to a push notification from the IAM Component 8 620 and generates a user notification. It then shows a random number which is communicated to the IAM. To login to the secure application (Components 9 610 and 10 622) the user must type that code in which the IAM can verify, thereby proving they have access to the secondary device (Component 2 606) and intended to gain access to the secure application on the primary device (Component 1 602) (otherwise, they would not have entered the code).

Components 12a/b 618 634 Proximity estimators: An extremely simple form of proximity asserts that the secondary device is in immediate proximity to the primary device. This can be constructed as a software module that uses a Bluetooth transceiver on both devices and provides a decent indicator of the distance between the primary and secondary devices. Some devices offer this feature, but for others, the RSSI value from each chip listening to the other can be used, and along with some experimentation measuring the RSSI values at different distances, to get a lookup table or function to obtain distance from RSSI can be constructed. This distance can then be communicated to Components 6a/b 614 630.

The foregoing systems and methods may be varied in numerous ways.

A. Behavioral biometrics can run only on demand instead of continuously, such that they execute when they are needed or requested, and not at all times.

B. Tertiary and further devices may also be used to improve accuracy, security and usability of the system. These devices would mirror the structure of the secondary device (Component 2 606) with the omission of all or some of Components 11 624, 4b 626, 6b 630, 3b 628 and network connectivity. For example, adding a smartwatch to the system would improve security, friction reduction, and reliability.

C. Instead of an application (Component 9 610), BIMFA can be used to protect login access to the primary device entirely. This can employ primary device behavioral biometrics across first factor authentication.

D. One could connect the behavioral biometrics components of both units to each other, and instead of using historical data of observations, analyze similarities between the sensor signals on both devices in relation to each other, and from there decide if they are generated by the same user, possibly also in correlation with some other indicator of identity on the primary or secondary device. For example, if both devices are being carried by the same user, the motion signals would be highly correlated, indicating that the same user is in control of both.

E. One could remove the behavioral biometrics components (Components 4a/b 612 626) and use only the intent estimator (Components 5a/b 616 632) with proximity to authenticate, for example if a given example only required the user to have two devices, and it is assumed or shown that a specific type of attacker would not.

F. One could reimplement the intent estimators (Components 5a/b 616 632) to analyze similarities between the sensor signals on both devices in relation to each other, and from there decide in this way if the authorized user intended to perform this action. For example, if devices are carried by the same user, it can be assumed that any action taken was taken on that user's behalf.

G. Components 12a/b 618 634 may be reflexive, meaning the methods on Components 1 602, 2 606 respectively arrive at an identical solution for the same set of circumstances, but must not necessarily be implemented in this way, meaning that components on the primary and secondary devices may arrive at different conclusions of intent and proximity at the same time. Here a fusion algorithm is best suited that combines available inputs into the most accurate decision.

H. On failure to pass manual MFA in Step 9 610, the system may proceed directly to Step 10 622 and lock down, or the user may have a fixed number of attempts before the system locks down. Alternatively, the system may revert to Step 2 720 and repeat the entire BIMFA attempt. This may also be governed by the IAM (Component 8 620).

I. Components 6a/b 614 630 may only use inputs form their own respective behavioral biometrics, intent, and proximity estimators (Components 4a/b 612 626 and 5a/b 616 632), however information from the other device may be relayed to each other, either P2P, directly via the network, or via the IAM (Component 8 620) or other proxy.

J. The authentication engines (Components 6a/b 614 630) may also not make access decisions themselves but provide information to the IAM (Component 8 620) which makes a decision, relays this decision to Components 6a/b 614 630 respectively, which then take action.

K. After Step 8 in FIG. 7 780, the system may automatically revert to Step 2 720 even after successful BIMFA and continually perform BIMFA using the secondary device.

L. The behavioral biometrics (Components 4a/b 612 626) may not necessarily interpret behavior to authenticate the user. They could use the fact that the user authenticated successfully in the past and analyze the behavior not in a way that extracts the user's identity, but rather looks for user-independent behavior that ensures that the user has not, and could not have, changed since that previous authentication event. For example, if the user authenticated, and then continually typed on the device since then and that behavior was measured continuously, one could assume that it is still the same user without having to analyze the nature of that typing.

M. The IAM (Component 8 620) can be omitted with all user details and policies located on the Blockchain, or on the devices, for example in the authentication engine (Components 6a/b 614 630).

N. Components 6a/b 614 630 may initiate manual MFA (Component 11 624) directly through P2P connectivity, either through a local IAM module (Component 8 620) or without one by communicating directly with the MFA component over the P2P network.

O. One could also construct the system such that if both behavioral biometric Components 4a/b 612 626 are in agreement that this is certainly not the authorized user, the system executes another additional step that is a complete lock down that can only be lifted by a system administrator. In this way, if both the primary and secondary devices (Components 1/2 602 606) have been compromised, as well as the first factor for each (e.g. password or pin), BIMFA can still be used to prevent unauthorized access.

P. The system may also use application inputs, and based on application information, decide how risky a certain action is. Based on that risk, thresholds can be adapted to dynamically decide which level of certainty is required to perform BIMFA. In this way, actions requiring low levels of certainty can be accessed using BIMFA, even under slightly uncertain conditions.

Q. In FIG. 7, Steps 2/3/4 720 730 740 can be executed in any preferred order, or all in parallel without affecting performance.

R. Intent may be estimated by only the primary, or only the secondary device, without collaboration needed.

S. Proximity may be estimated by only the primary, or only the secondary device, without collaboration needed.

T. Step 9 790 and manual MFA (Component 11 624) may be omitted, where a failed BIMFA attempt results in ultimate failure (Step 10 795) or some other action.

U. Apart from Components 1, 2, 602 606 all components can be on their respective devices, or located on a third device, server, or the cloud, with data connectivity. Sensor observations from Components 3a/b 608 628 would then be offloaded or gathered from remote sensing, and the process would proceed remotely with the conclusions on granting or revoking access being returned to the respective devices. The resulting security and user experience remain unchanged.

V. The primary device (Component 1 602) may be a virtual device, in which case some sensors (Component 3a 608) will be located on the input device, to estimate intent, or some other method of intent estimation is used that does not require physical sensors. Alternatively, Component 3a 608 may be inside the virtual device, for example sensing the characters and mouse movements as they are executed and not on the input devices.

W. Apart from Components 1, 2 602 606, and the physical components of 3a/b 608 628, all components can be one their respective devices, or located on the Blockchain and implemented as smart contracts.

X. Remote resources (Component 7 604) may be omitted, with all necessary components located on the devices (Components 1, 2 602 606) to enable offline performance, using only peer-to-peer (P2P) connectivity.

Y. Application components (Components 9, 10 610 622) may be a hardware component, such as smart, connected door lock, that implements a physical action, such as unlocking, or a connected ATM that emits cash on authentication.

Z. The primary (Component 1 602) and secondary (Component 2 606) devices may switch roles at any time. This can happen for example, if the user wishes to log in to, or use a secure application on, the secondary device. The secondary becomes the current primary at that point, and the previous primary becomes the current secondary. The only precondition is that there is also a secure application on or accessible from the former secondary device (Component 9 610 or 10 622), and a manual MFA (Component 11 624) or BIMFA application on the former primary device, if manual MFA is needed (BIMFA can work without manual MFA, see below).

AA. It is possible to construct this invention in such a way that the transitions to Step 9 790 and 10 795 are disabled, meaning that BIMFA will allow a user to gain access and manual MFA (Component 11 624) is disabled, even if the user appears to be unauthorized with high confidence (passive BIMFA). This may allow BIMFA to be used as an auditing tool only for retroactive incident or activity analysis. The knowledge that a user is unauthorized may be used for different or defensive or offensive purposes. Further, if the behavioral authenticator determines that the user is not authorized and may not perform the secure user action, the behavioral authenticator grants access while using a negative authentication status to change system behavior.

BB. One could create a false secure application state (a modification of Components 9/10 610 622) that appears without notification if the user is able to pass manual authentication but is clearly identified as unauthorized by their behavior. In this way a honeypot is created that fools the attacker into thinking they have succeeded and distracts them while preventing a breach until they can be caught red-handed in the act of a cyberattack.

CC. The behavioral biometric components (Components 4a/b 612 626) and intent estimators (Components 5a/b 616 632) could be augmented, modified, or replaced with similar components that, instead of authenticating a user, would model and detect the difference between human behavior and bot behavior. In this way, BIMFA would ensure that the user is indeed human, and further protect the system against automated malicious attacks and scraping.

DD. The behavioral biometric components (Components 4a/b 612 626), intent estimators (Components 5a/b 616 632) and proximity estimators (Components 12a/b 618 634) could be augmented, modified, or replaced with similar components that, instead of only authenticating a user, would contain a model or several models that would first identify the user out of a pool of several authorized users and authenticate them as well. In this way multiple users would be able to securely use the same devices using BIMFA, while still rejecting unauthorized attempts for any users not in the pool.

EE. Similarly, this system could be used to behaviorally authenticate a pool of users that are unauthorized and deny them access even if they would be otherwise authenticated.

FF. The IAM component (Component 11 624) may be on a tertiary device that is not being used for BIMFA, for example a smart watch could be used for BIMFA, with a mobile phone serving as a host for Component 11 624, or a CAC card or other device may be required for manual MFA.

GG. A remote application may be accessible only through a local application, such as a web browser, and not be directly accessible or access controllable by Components 6a/b 614 630. However, a plugin for the local host application which informs the local BIMFA system of browser behavior can be integrated. In this way, local BIMFA will only grant access if the plugin informs it that the secure action is being conducted locally.

HH. Components 6a/b 614 630 may not require all inputs to be present to authorize BIMFA. For example, a policy could be implemented that only a certain subset of outputs from Components 4a/b 612 626, 5a/b 616 632 and 12a/b 618 634. For example, only one of either Component 4a 612 or 4b 626 maybe enough to perform BIMFA, or any other subset of inputs. This decision can be made as a policy, or Components 6a/b 614 630 themselves based on their internal confidence after fusing the elements that are available in real time.

II. Components 12a/b 618 634 (proximity) may be asymmetric and non-reflexive without requiring any interaction. For example, a magnet and a magnetic field sensor may be used to implement ranging that do not require communication with each other, or a remote proxy, but range is only available on a single device. Another example is audio emitted on one device in a frequency range that is not audible to humans at a specific decibel A-weighting (dBa), but the dBa on the other device can be used to estimate distance.

JJ. Proximity estimators (Components 12a/b 618 634) may also measure uniquely identifying information. Therefore, proximity data may be a valuable input into the behavioral biometrics (Components 4a/b 612 626), or into a machine-learning based implementation of the authentication engines (Components 6a/b 614 630). For example, if a certain user always works a specific distance from their laptop, other distances may be indicative of an intruder.

KK. The sensors in Components 3a/b 608 628 maybe location on the respective devices, or off device in the environment, such as motion sensors, cameras or microphones in the workplace, or a combination of both. These remote sensory inputs are then fed into the behavioral biometrics (Components 4a/b 612 626), the intent estimators (Components 5a/b 616 632) and the proximity estimators (Components 12a/b 618 634).

LL. Although BIMFA is implicit and therefore invisible to the user experience, it may be built in such a way as to notify the user in a non-destructive way that it has occurred, such as a notification on the primary and/or secondary and/or tertiary devices. This would serve as a backup for the user to (1) alert an administrator if it occurred in error, and (2) to inform the system of erroneous behavior that allows the various machine learning processes involved to improve themselves and prevent that error from occurring again.

Use of the invention may be implemented in various ways.

The invention can be deployed to laptops (primary device) and smartphones (secondary device) of enterprise employees. In this way, if the employee has their phone with them while they are working on their laptop, MFA will be conducted using BIMFA. When MFA is required, it will occur invisibly without needing to interrupt the employee for manual MFA. In this way, MFA can occur more frequently, for more actions, including logging in to the laptop, using secure local applications such as VPN clients, and using secure remote applications such as web email clients, or even for every single keystroke.

Should an attacker gain access to that employee's credentials, they will attempt to login when the authorized employee is not present and interacting. For that reason, the lack of intent and/or the lack of proximity will flag this as an action not viable for BIMFA, and trigger manual MFA on the employee's device. Since this was not the employee's intent to grant access, the employee can now alert administrators to the attempted breach. Should the attacker compromise the employee's password, as well as the employee's primary device, the primary device's behavioral component, as well as missing intent, will flag the operation for manual MFA, alerting the employee and preventing the attack. Should the attacker gain access through an exploit, the behavioral biometric component will lock the system.

In the case of an accidental BIMFA rejection of an authorized employee, the employee will have to execute manual MFA to gain access, and in the worst case, seek help from an administrator.

With continuous intent, behavior, proximity and location, administrators can quickly see who is on campus and who is off the premises, thereby further preventing social engineering attacks against employees.

The BIMFA system can also be used to flag fraudulent usage or attacks without preventing them. For example, it is often advantageous to catch a criminal red-handed, and many organizations use honeypots for this purpose. The invention can be used by disabling Steps 9 790 and 10 795 to know the user is not authorized, but without preventing the attacks. These steps would then be replaced by an administrator notification component and step that would alert administrators and authorities.

Similarly, using BIMFA or a passive version presented in the previous paragraph, one has an auditable historical trace of continuous biometric user identity for auditing purposes and incident post-mortems. This could also be used, given historical data, to identify a culprit retroactively.

Having continual authentication on and across devices allows devices to be authenticated into corporate Wi-Fi in a secure fashion. In this way network security is increased, as unauthorized use can disconnect a device and revoke its network access token.

The intent estimators can also be used to predict which action the user intends to perform and execute that action in a secure and authenticated fashion proactively to create implicit interaction.

BIMFA may be used for password-less login. In this use case, BIMFA may be used without the aid of Component 4a 612, as there may be no interaction measurable. However, other forms of behavioral measurements may be leveraged, for example ambient sensors or cameras. This is particularly valuable in combination with facial or voice recognition biometrics. The confidence of those components can supplant the primary device behavioral authentication in the BIMFA architecture or be combined if there are some behavioral observations available.

BIMFA running on primary and secondary devices may be used to pass authentication to other devices with no UI, but the ability to implement one or more of the necessary components. For example, a tiny application on a fitness tracker, if worn by a person carrying one or more devices implementing BIMFA, would be able to verify authorization through correlated behavioral biometrics and receive an authentication token from the BIMFA device. This token could be valid for a period of time, or even be validated using behavioral biometrics, intent estimation and proximity as a full BIMFA device.

As an incidental benefit, lost or stolen devices can be quickly identified using behavioral biometrics (Components 4a/b 612 626) and the administrator notified of the situation. In that case remote lock, and even wipe can then be triggered by the administrator. Also, if so wished, the system can proactively wipe the devices as soon as unauthorized control or interaction is detected.

As an incidental benefit, employee productivity increases due to the deployment of BIMFA. This is partially due to saving the time spent for manual MFA on the part of the employees, but also beyond that, due to increased focus and lack of context required for handling MFA interrupts.

Should the attacker compromise the passwords of the primary and secondary device, the primary device, and the secondary device, the behavioral components of both devices together will flag this action as below the threshold for MFA, flagging the administrator and locking the system down completely until the administrator re-enables it. For the authorized user, MFA is implicit and invisible through BIMFA. For an unauthorized attacker, multiple devices must be compromised, as well as multiple passwords and manual MFA, and even then, they are blocked by behavioral biometrics and a breach is prevented.

BIMFA may also be used to create a dashboard that displays aggregate risk across an organization as represented by the number of failed attempts and unauthorized users detected over time, while at the same time protecting individual devices, accounts and identities.

Because of BIMFA, attacks themselves may be reduced, specifically spear fishing and social engineering attempts, as compromising credentials no longer provides access.

### III. CONCLUSION

The preceding description and illustrations of the disclosed embodiments is provided to enable a person skilled in the art to make or use the present invention. Various modifications to these embodiments will be clear to those skilled in the art, and the generic principles defined herein may be applied to other embodiments without departing from the spirit or scope of the invention. Thus, the present invention is not intended to be limited to the embodiments shown herein but is to be accorded the widest scope consistent with the principles and novel features disclosed herein. While various aspects and embodiments have been disclosed, other aspects and embodiments are possible. The various aspects and embodiments disclosed are for purposes of illustration and are not intended to be limiting

In the foregoing specification, specific embodiments have been described. However, one of ordinary skill in the art appreciates that various modifications and changes can be made without departing from the scope of the invention as set forth in the claims below. Accordingly, the specification and figures are to be regarded in an illustrative rather than a restrictive sense, and all such modifications are intended to be included within the scope of present teachings.

Moreover, in this document, relational terms such as first and second, top and bottom, and the like may be used solely to distinguish one entity or action from another entity or action without necessarily requiring or implying any actual such relationship or order between such entities or actions. The terms “comprises,” “comprising,” “has”, “having,” “includes”, “including,” “contains”, “containing” or any other variation thereof, are intended to cover a non-exclusive inclusion, such that a process, method, article, or apparatus that comprises, has, includes, contains a list of elements does not include only those elements but may include other elements not expressly listed or inherent to such process, method, article, or apparatus. An element proceeded by “comprises . . . a”, “has . . . a”, “includes . . . a”, “contains . . . a” does not, without more constraints, preclude the existence of additional identical elements in the process, method, article, or apparatus that comprises, has, includes, contains the element. The terms “a” and “an” are defined as one or more unless explicitly stated otherwise herein. The terms “substantially”, “essentially”, “approximately”, “about” or any other version thereof, are defined as being close to as understood by one of ordinary skill in the art. The term “coupled” as used herein is defined as connected, although not necessarily directly and not necessarily mechanically. A device or structure that is “configured” in a certain way is configured in at least that way but may also be configured in ways that are not listed.

The Abstract of the Disclosure is provided to allow the reader to quickly ascertain the nature of the technical disclosure. It is submitted with the understanding that it will not be used to interpret or limit the scope or meaning of the claims. In addition, in the foregoing Detailed Description, various features are grouped together in various embodiments for streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus, the following claims are hereby incorporated into the Detailed Description, with each claim standing on its own as a separately claimed subject matter.

1. A system comprising:
at least one sensor for gathering current sensor data associated with a current subject;
a feature learning module that learns best features to distinguish the current subject from other subjects;
a sensor observation engine for collecting the current sensor data from the at least one sensor;
a classification module for comparing features from first historical sensor data associated with the current subject, second historical sensor data associated with at least one non-current subject and the current sensor data to produce authentication probability data; and
an authentication module for providing the authentication probability data to an application.

2. The system as in claim 1, further comprising:
a subject data storage device for storing the current sensor data associated with the current subject and the first historical sensor data;
an external data storage device for storing the second historical sensor data.

3. The system as in claim 1, further comprising:
a data preprocessing module for processing the current sensor data, the first historical sensor data and the second historical sensor data into preprocessed windows;
a model training module for building models based on the preprocessed windows to learn specific features differentiating the current subject from the other subjects to produce current subject model data.

4. The system as in claim 1, further comprising:
an analog-to-digital converter for converting analog portions of the current sensor data into digital portions of the current sensor data and providing the digital portions of the current sensor data to the sensor observation engine.

5. The system as in claim 1, wherein the data preprocessing module engages in the processing of the current sensor data, the first historical sensor data and the second historical sensor data into preprocessed windows by resampling across the current sensor data, the first historical sensor data and the second historical sensor data.

6. The system as in claim 5, wherein the preprocessed windows are generated via a sliding window technique.

7. The system as in claim 1, wherein the model training module segregates the current sensor data and the first historical sensor data from the second historical sensor data.

8. The system as in claim 7, wherein the model training module distinguishes the current sensor data and the first historical sensor data from the second historical sensor data to learn features about the current subject to produce current subject model data.

9. The system as in claim 7, wherein the model training module uses a deep neural network for feature learning about the subject.

10. The system as in claim 7, wherein model training module does not use a deep neural network for feature learning about the subject.

11. The system as in claim 9, wherein the deep neural network generates a probability that a specific preprocessed windows was generated by the current subject and incorporates that probability into the current subject model data.

12. The system as in claim 1, further comprising:
an identification module that uses subject-specific features from many subjects to identify the subject from data of unknown origin for providing identification data to an application.

13. The system as in claim 1, wherein the current subject and the non-current subject are the same individual.

14. A system comprising:
a primary device for interacting with a user performing a secure user action;
a secondary device in proximity with the user;
a first sensor for collecting first sensor data;
a first behavioral biometric component for determining whether the first sensor data results from behavior of the user and outputting first behavioral biometric data;
a first proximity estimator, wherein the first proximity estimator estimates the distance between the primary device and the second device and outputs distance data; and
a first authentication engine, wherein the first authentication engine processes the first behavioral biometric data and the distance data to determine an authentication status for the secure user action and outputting authentication data.

15. The system as in claim 14, wherein the first sensor and the first behavioral biometric component are associated with the same device.

16. The system as in claim 14, wherein the first sensor and the first behavioral biometric component are associated with a different device.

17. The system as in claim 14, further comprising:
a second sensor for collecting second sensor data;
a second behavioral biometric component for determining whether the second sensor data results from behavior of the user and outputting second behavioral biometric data;
a second proximity estimator, wherein the second proximity estimator along with the first proximity estimator estimate the distance between the primary device and the secondary device and outputs distance data; and
a second authentication engine, wherein the second authentication engine along with the first authentication engine process the first behavioral biometric data, the second behavioral biometric data, and the distance data to determine an authentication status for the user action and outputting authentication data.

18. The system as in claim 17, wherein the first sensor and the second sensor are located on a host system not located on the first device and not located on the second device.

19. The system as in claim 17, wherein the first sensor is associated with the primary device;
wherein the second sensor is associated with the secondary device;
wherein the first behavioral biometric component is associated with the primary device;
wherein the second behavioral biometric component is associated with the secondary device;
wherein the first proximity estimator is associated with the primary device; and
wherein the second proximity estimator is associated with the secondary device.

20. The system as in claim 19, further comprising:
a first intent estimator associated with the primary device for determining whether the first sensor data was generated based on intentional secure action of the user and outputting first intent data;
a second intent estimator associated with the secondary device for determining whether the first sensor data was generated based on intentional secure action of the user and outputting second intent data; and
wherein the first authentication engine and the second authentication engine process the first intent data and the second intent data along with the first behavioral biometric data, the second behavioral biometric data and the distance data to determine an authentication status for the user action and outputting authentication data.

21. The system as in claim 14, further comprising:
a behavioral authenticator for processing the authentication data to determine whether the user may perform the secure user action.

22. The system as in claim 14, further comprising:
a behavioral multi-factor authentication application that does not require direct interaction by the user.

23. The system as in claim 22, wherein the behavioral multi-factor authentication application operates on a nearly continuous basis.

24. The system as in claim 19, further comprising a secure application that has application data related to transactional operations with the secure application; and
wherein the first authentication engine and the second authentication engine process application data along with the first intent data and the second intent data, the first behavioral biometric data, the second behavioral biometric data and the distance data to determine an authentication status for the user action and outputting authentication data.

25. The system as in claim 19, wherein the first authentication engine and the second authentication engine use historical data associated with the user.

26. The system as in claim 20, wherein the first intent estimator and the second intent estimator collaboratively establish intent of the user and generate the first intent data and the second intent data.

27. The system as in claim 19, wherein if the behavioral authenticator is unable to determine whether the user may perform the secure user action, the behavioral authenticator causes the secondary device to perform a second multi-factor authentication that requires direct interaction by the user.

28. The system as in claim 19, wherein if the behavioral authenticator determines that the user may not perform the secure user action, the behavioral authenticator causes the primary device to lock.

29. The system as in claim 19, wherein if the behavioral authenticator determines that the user may not perform the secure user action, the behavioral authenticator causes a secure application to lock.

30. The system as in claim 19, wherein if the behavioral authenticator determines that the user is not authorized and may not perform the secure user action, the behavioral authenticator grants access while using a negative authentication status to change system behavior.

31. The system as in claim 19 wherein the behavioral authenticator causes the primary device to delete data.

32. The system as in claim 19, wherein the behavioral authenticator causes a secure application to delete data.

33. The system as in claim 19, wherein if the behavioral authenticator determines that the user may perform the secure user action, the behavioral authenticator causes the primary device to unlock.

34. The system as in claim 19, wherein if the behavioral authenticator determines that the user may perform the secure user action, the behavioral authenticator causes a secure application to unlock.

35. A system comprising:
a primary device for interacting with a user performing a secure user action;
at least one secondary device in proximity with the user;
a sensor for collecting sensor data;
a behavioral biometric component for determining whether the sensor data results from behavior of the user and outputting behavioral biometric data;
a proximity estimator for estimating distances among the primary device and each of the at least one secondary devices and outputting distance data; and
an authentication engine for processing the behavioral biometric data and the distance data to determine an authentication status for the secure user action and outputting authentication data.
